(19) United States
(12) Patent Application Publication
(10) Pub. No.: US 2009/0071440 A1
(43) Pub. Date: Mar. 19, 2009

(54) DIRECT INJECTION SPARK IGNITION INTERNAL COMBUSTION ENGINE AND FUEL INJECTION CONTROL METHOD FOR SAME ENGINE

(75) Inventor: Takeshi Ashizawa, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/282,660

(22) PCT Filed: Aug. 3, 2007
(86) PCT No.: PCT/IB2007/002235

§ 371 Date: Sep. 12, 2008

(30) Foreign Application Priority Data
Aug. 4, 2006 (JP) 2006-213393

(51) Int. Cl. F02P 5/04; F02D 41/30

(52) U.S. Cl. 123/406.29; 701/105

(57) ABSTRACT

A direct injection spark ignition internal combustion engine includes a fuel injection controller preventing and/or suppressing engine knocking by retarding a fuel injection timing near an intake stroke bottom dead center. The fuel injection controller retards the fuel injection timing beyond a predetermined time by injecting a required amount of fuel through two or more split injections, and the time at which to end the last split injection is set to a time later than the predetermined time.

### BACKGROUND OF THE INVENTION

1. Field of the Invention

The invention relates to a direct injection spark ignition internal combustion engine and to a fuel injection control method for the same engine.

2. Description of the Related Art

In a direct injection spark ignition internal combustion engine, when fuel is injected in the latter half of each compression stroke to perform stratified combustion, the temperature in the cylinder tends to decrease due to the vaporization latent heat that is generated as the injected fuel vaporizes. Such a decrease in the cylinder temperature reduces the possibility of engine knocking. In view of this, it has been proposed to suppress or prevent engine knocking by prohibiting retardation of the ignition timing (For example, refer to Japanese Patent Application Publication No. JP-A-2000-205095 (JP-A-2000-205095)).

In a direct injection spark ignition internal combustion engine, when fuel is injected at a time near the intake stroke bottom dead center to perform homogenous combustion, the intake air temperature decreases due to the vaporization latent heat that is generated as the injected fuel vaporizes, whereby the intake charge efficiency increases. Therefore, by retarding the fuel injection timing to an extent that the intake valves are closed before the intake air temperature decreases significantly, the aforementioned increase in the intake charge efficiency can be minimized and thus engine knocking can be prevented or suppressed accordingly.

Thus, if the fuel injection timing is retarded to an extent that the fuel injection starts after the intake valves are closed, the aforementioned increase in the intake charge efficiency, which results from a decrease in the intake air temperature, can be prevented. Moreover, if the fuel injection timing is further retarded, the intake air temperature further decreases due to the vaporization latent heat and thus remains low until the time of ignition despite the heat transferred from the cylinder bore wall, and this is also effective to prevent or suppress engine knocking. That is, the more the fuel injection timing is retarded, the more effectively engine knocking can be prevented or suppressed.

However, the more the fuel injection timing is retarded, the more likely it is for the injected fuel to hit the top face of the piston and adhere thereto. The fuel on the top face of the piston does not vaporize sufficiently before ignition, and therefore some of such fuel vaporizes during the compression stroke and thus is discharged from the cylinder as unburned fuel.

### SUMMARY OF THE INVENTION

The invention provides a direct injection spark ignition internal combustion engine and a fuel injection control method for the same engine that can largely retard the fuel injection timing while preventing or minimizing an increase in the amount of unburned fuel.

A first aspect of the invention relates to a direct injection spark ignition internal combustion engine including fuel injection controlling means for preventing and/or suppressing engine knocking by retarding a fuel injection timing near an intake stroke bottom dead center. The fuel injection controlling means retards fuel injection end timing beyond a predetermined time by injecting a required amount of fuel through two or more split injections. At this time, the fuel injection controlling means sets the time at which to end the last split injection to a time later than the predetermined time.

According to the first aspect of the invention, when the fuel injection end timing is retarded beyond the predetermined time to prevent or suppress engine knocking, the required amount of fuel is injected through two or more split injections. Thus, the amount of fuel to be injected at one time is small and this facilitates fuel vaporization. Thus, if the time to end the last split injection is set to a time later than the predetermined time, each injected fuel does not hit the top face of the piston, and therefore the amount of unburned fuel decreases.

A second aspect of the invention relates to a direct injection spark ignition internal combustion engine according to the first aspect of the invention, wherein the fuel injected at the time near the intake stroke bottom dead center is directed to intensify a tumble flow in a cylinder.

According to the second aspect of the invention, fuel is injected at the time near the intake stroke bottom dead center in the direction to intensify the tumble flow in the cylinder. Therefore, the movement of air-fuel mixture, due to the intensified tumble flow, can be maintained strong until ignition, so that the combustion speed increases.

A third aspect of the invention relates to a fuel injection control method for a direct injection spark ignition internal combustion engine including fuel injection controlling means for preventing and/or suppressing engine knocking by retarding a fuel injection timing near an intake stroke bottom dead center. In this fuel injection control method, a fuel injection end timing is retarded beyond a predetermined time by injecting a required amount of fuel through two or more split injections, and the time at which to end the last split injection is set to a time later than the predetermined time.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a vertical cross-sectional view schematically showing the structure of each cylinder of a direct injection spark ignition internal combustion engine according to an exemplary embodiment of the invention when the piston is near the bottom dead center on an intake stroke; and

FIG. 2 is a timechart illustrating fuel injection control for preventing and suppressing engine knocking.

### DETAILED DESCRIPTION OF EMBODIMENTS

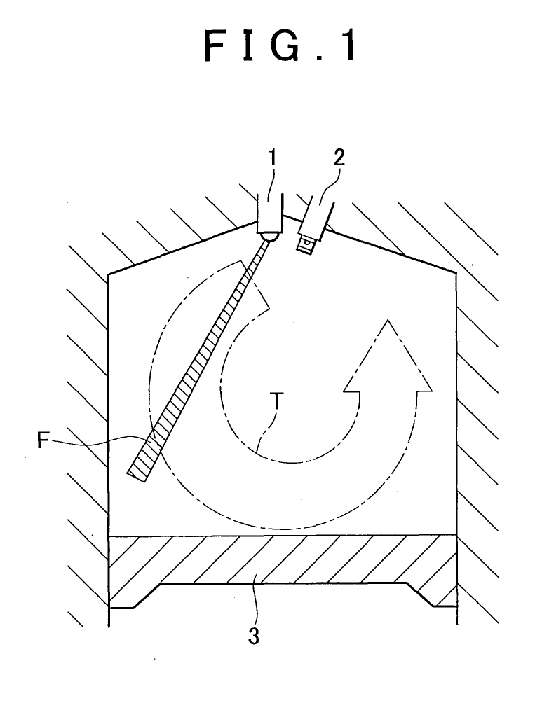

FIG. 1 is a vertical cross-sectional view schematically showing the structure of each cylinder of a direct injection spark ignition internal combustion engine according to an exemplary embodiment of the invention. Specifically, FIG. 1 shows the state near the bottom dead center on an intake stroke (will be referred to as “intake stroke bottom dead center”) that corresponds to the time of fuel injection for homogenous combustion. Referring to FIG. 1, a fuel injector 1 is provided at substantially the center of the upper area of the cylinder to inject fuel directly into the cylinder. Also, in the cylinder, an ignition plug 2 is provided near the fuel injector 1 on the intake valve side thereof and a piston 3 is provided. Although not shown in the drawings, a pair of intake valves are provided on the right side above the cylinder and a pair of exhaust valves are provided on the left side above the cylinder.

In the direct injection spark ignition internal combustion engine of the exemplary embodiment, homogenous combustion is performed by injecting fuel directly into each cylinder so that a homogenous air-fuel mixture is formed at the time of ignition in the cylinder and then igniting the formed homogenous air-fuel mixture by an electric spark. For example, the crank angle at which to start fuel injection is set based on the fuel injection amount such that the fuel injection will end at a crank angle near the intake stroke bottom dead center, or the crank angle at which to start fuel injection is set to the latter half of each intake stroke irrespective of the fuel injection amount.

The fuel injector 1, as shown in FIG. 1, injects fuel F obliquely downward to the exhaust valve side wall of the cylinder bore (preferably to the lower portion of the exhaust valve side wall of the cylinder bore). The thrust force of the fuel F injected from the fuel injector 1 is set such that the front of the injected fuel F reaches the point at least 60 mm away 1 msec after the beginning of the fuel injection.

As the injected fuel F having such a large thrust force moves obliquely downward from substantially the center of the upper side of the cylinder toward the exhaust valve side wall of the cylinder bore (preferably to the lower portion of the exhaust valve side wall of the cylinder bore), the thrust force of the injected fuel F intensifies a tumble flow T that has been created in the cylinder. The tumble flow T flows downward in the exhaust valve side of the cylinder and upward in the intake valve side. The tumble flow T thus intensified remains active until the latter half of the compression stroke, whereby the movement of air-fuel mixture can be kept strong until the time of ignition that comes at the end of the compression stroke. The strong movement of air-fuel mixture increases the combustion speed, so that the homogenous combustion progresses in a good condition.

The shape into which fuel F is injected may be arbitrarily selected from among various shapes. For example, using a single injection hole, the fuel F can be injected into, for example, the shape of a solid or hollow cone. Further, using a slit-shaped injection hole, the fuel F can be injected into a relatively thin fan-like shape. Further, using an arc-slit-shaped injection hole, the fuel F can be injected into a relatively thin arc shape, the convex side of which faces the upper side and the exhaust valve side. Further, using a combination of two or more straight-slit-shaped injection holes, the fuel F can be injected into a zigzag shape. In short, the fuel F may be injected into any shape as long as the thrust force of the injected fuel F can be made large enough to accelerate the tumble flow T in the cylinder.

In this exemplary embodiment, because the ignition plug 2 is provided on the intake valve side of the fuel injector 1, the ignition plug 2 does not get wet due to the fuel that is injected form the fuel injector 1 toward the exhaust valve side wall of the cylinder, and therefore the ignition plug 2 can appropriately generate electric arcs at the time of ignition.

In this exemplary embodiment, in order to save the fuel consumption, the air-fuel ratio for homogenous combustion is set to a ratio that is leaner than the stoichiometric air-fuel ratio (preferably a lean air-fuel ratio that suppresses the production of NOx), and therefore homogenous combustion tends to progress slowly. Thus, increasing the combustion speed as described above provides various advantages. Meanwhile, the air-fuel ratio for homogenous combustion may alternatively be set to the stoichiometric air-fuel ratio or to a rich air-fuel ratio. In this case, too, increasing the combustion speed provides various advantages.

When fuel is injected into the cylinder at a time near the intake stroke bottom dead center, the intake air temperature in the cylinder decreases due to the vaporization latent heat that is generated as the fuel vaporizes in the cylinder, and this increases the intake charge efficiency. However, when a knock sensor provided in the engine detects the engine knocking, the intake air amount is preferably reduced to suppress it.

At this time, if the fuel injection timing is retarded to an extent that the intake valves are closed before the injected fuel vaporizes sufficiently, the aforementioned increase in the intake charge efficiency can be minimized and thus the intake air amount can be reduced accordingly. When reducing the intake air amount in this manner, the intake air amount decreases with a higher response than that with which the intake air amount decreases in response to the opening degree of the throttle valve being reduced.

Further, if the fuel injection timing is retarded to an extent that the fuel injection starts after the intake valves are closed, the aforementioned increase in the intake charge efficiency, which is caused by the vaporization latent heat, can be prevented. Further, as the fuel injection timing is retarded, the time period from fuel injection to ignition shortens. Thus, the temperature of the intake air that has decreased due to the vaporization latent heat tends to remain low until the time of ignition despite the heat transferred from the cylinder bore wall. That is, the more the fuel injection timing is retarded, the more effectively engine knocking can be prevented or suppressed.

As such, when the engine is knocking, one option may be to retard the fuel injection timing until the engine knocking stops. However, at this time, if the injection timing is simply retarded, it may cause the injected fuel to hit the top face of the piston 3. Because the fuel on the top face of the piston 3 vaporizes not before ignition but during the expansion stroke, the larger the amount of the fuel on the top face of the piston 3, the larger the amount of unburned fuel in exhaust gas will be.

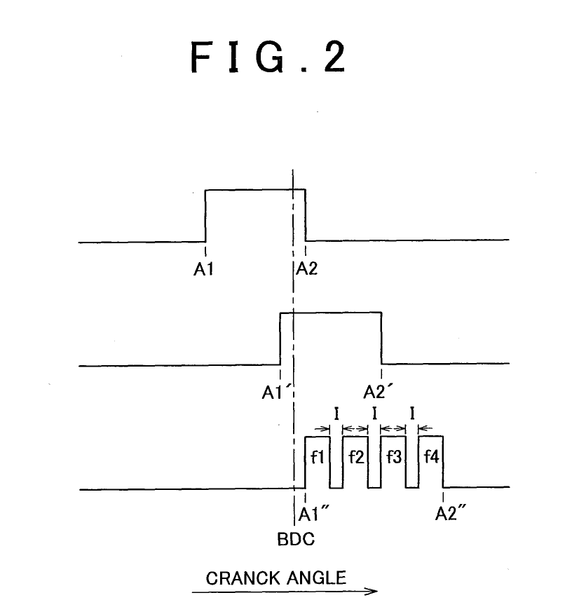

In view of the above, in the direct injection spark ignition internal combustion engine of this exemplary embodiment, when retarding the fuel injection timing, the fuel injection is controlled as illustrated in FIG. 2 in order not to increase the amount of unburned fuel. FIG. 2 shows timecharts each indicating the crank angle at which to start fuel injection and the crank angle at which to end the fuel injection. The upper timechart of FIG. 2 indicates a fuel injection timing near the intake stroke bottom dead center in a state where the engine is not knocking. In this case, fuel is injected during the time period from a fuel injection start crank angle A1 in the latter half of the intake stroke to a fuel injection end crank angle A2 immediately after the intake stroke bottom dead center (BDC).

If the engine starts knocking while fuel is being injected at the fuel injection timing described above, the fuel injection timing is retarded. As a result, the intake charge efficiency decreases and the crank angle range from the end of fuel injection to the time of ignition becomes narrower, which enables the temperature of the intake air, which has decreased due to the vaporization latent heat, to remain low until the time of ignition and thus suppress the knocking of the engine. This fuel injection timing retardation is performed by retarding the fuel injection start timing and the fuel injection end timing by the same angle until the fuel injection end crank angle, which corresponds to the time to end the fuel injection, reaches a predetermined crank angle A2′ shown in the middle timechart in FIG. 2.

In the case where the fuel injection end timing needs to be retarded beyond the predetermined crank angle A2′ in order to suppress the knocking of the engine, if the fuel injection timing is simply retarded, the position of the piston 3 at the fuel injection end timing will become relatively high, and therefore the distance form the fuel injector 1 to the piston 3 will be short correspondingly. In this case, a relatively large portion of the fuel hits the top face of the piston 3 before vaporizing and thus adheres to the top face of the piston 3.

To counter this, in this exemplary embodiment, as shown in the lower timechart in FIG. 2, the fuel injection for injecting the required amount of fuel is divided into two or more split injections (e.g., four split injections f1 to f4) so that the last split injection (f4) is performed at A2″ that is later than the predetermined crank angle A2′. As such, the amount of fuel injected at one time decreases, and this enables each injected fuel to vaporize easily even if the distance the injected fuel moves in the cylinder is short. As a result, the amount of fuel that adheres to the top face of the piston 3 decreases sufficiently, whereby the amount of unburned fuel that is formed by the fuel adhering to the top face of the piston 3 decreases accordingly.

In the lower timechart in FIG. 2, the crank angle at which to start the first split injection f1 is set to A″ that is later than the fuel injection start crank angle A′ in the middle timechart. However, because intervals I are provided between the split injections when dividing the fuel injection, the crank angle range from the crank angle at which to start the first split injection to the crank angle at which to end the last split injection is larger than the crank angle range over which the same amount of fuel is injected without dividing the fuel injection. As such, even if the crank angle at which to start the first split injection f1 is set to the same angle as the fuel injection start angle A1′ in the middle timechart, the crank angle at which to end the last split injection f4 is still later than the fuel injection end timing A2′ (predetermined crank angle) in the middle timechart, and therefore, during the fuel injection illustrated in the lower timechart, fuel can be effectively used to suppress the knocking of the engine as compared to during the fuel injection illustrated in the middle time chart.

The required fuel amount is set based on the engine operation state. For example, the required fuel amount is increased as the engine speed increases and as the engine load increases. In the case where the required fuel amount is thus controlled, the fuel injection end crank angle A2′ for the single fuel injection may be advanced as the required fuel amount increases. Further, the higher the engine speed, the faster the piston 3 rises up in the cylinder and thus the more likely it is for the injected fuel to adhere to the top face of the piston 3. Therefore, the fuel injection end crank angle A2′ for the singe fuel injection may be advanced as the engine speed increases.

Further, when the fuel injection is divided into two or more split injections, for the purpose of facilitating the vaporization of fuel injected at each split injection, the number of the split injections may be increased or each interval I may be extended as the required fuel amount increases. The later the fuel is injected, the more likely it is for the injected fuel to adhere to the top face of the piston 3. Therefore, when the fuel injection is divided into two or more split injections, the fuel injection amounts for the respective split injections may be made different from each other such that the later the injection, the smaller the amount of the injected fuel will be.

In this exemplary embodiment, fuel injection is divided when it is necessary to retard the fuel injection end crank angle beyond the predetermined crank angle A2′. For example, whether to divide fuel injection may be determined based on the fuel injection end crank angle calculated from the fuel injection start angle or based on the fuel injection start angle and the required fuel amount.

Generally, the ignition timing is retarded to prevent or suppress engine knocking. However, because retarding the ignition timing adversely affects the condition of combustion, it is desirable to avoid or minimize the retardation of the ignition timing as much as possible. However, if such ignition timing retardation is performed together with the above-described fuel injection retardation, the amount that the ignition timing needs to be retarded decreases.

In the exemplary embodiment, engine knocking is suppressed by retarding the fuel injection timing during homogenous combustion as described above. In the exemplary embodiment, further, when the engine load is lower than a predetermined load, stratified combustion may be performed by injecting fuel from the fuel injector 1 in the latter half of each compression stroke. To perform stratified combustion, for example, a cavity is formed in the top face of the piston 3 and the fuel injected in the latter half of the compression stroke is guided by the cavity to near the ignition plug 2, so that a combustible air-fuel mixture is formed near the ignition plug 2. Alternatively, if the ignition plug 2 is arranged on the exhaust valve side of the fuel injector 1, a combustible air-fuel mixture can be directly formed near the ignition plug 2 by injecting fuel from the fuel injector 1.

1-13. (canceled)

14: A direct injection spark ignition internal combustion engine, comprising:
a fuel injection controlling device that prevents and/or suppresses engine knocking by retarding a fuel injection timing near an intake stroke bottom dead center, wherein
the fuel injection controlling device retards a fuel injection end timing beyond a predetermined time by injecting a required amount of fuel through two or more split injections, the time at which to end the last split injection being set to a time later than the predetermined time.

15: The direct injection spark ignition internal combustion engine according to claim 14, wherein the fuel injected at the time near the intake stroke bottom dead center is directed to intensify a tumble flow in a cylinder.

16: The direct injection spark ignition internal combustion engine according to claim 14, wherein the predetermined time is an earliest fuel injection time that causes the injected fuel to hit a top face of a piston before vaporizing.

17: The direct injection spark ignition internal combustion engine according to claim 14, wherein the fuel injection controlling device increases a number of the split injections as the required amount of fuel increases.

18: The direct injection spark ignition internal combustion engine according to claim 14, wherein the fuel injection controlling device extends each interval between the split injections as the required amount of fuel increases.

19: The direct injection spark ignition internal combustion engine according to claim 14, wherein the fuel injection controlling device divides the required amount of fuel into fuel amounts to be injected at the respective split injections such that the later the injection, the smaller the amount of the injected fuel will be.

20: A fuel injection control method for a direct injection spark ignition internal combustion engine including fuel injection controlling device that prevents and/or suppresses engine knocking by retarding a fuel injection timing near an intake stroke bottom dead center, the fuel injection control method comprising:
retarding a fuel injection end timing beyond a predetermined time by injecting a required amount of fuel through two or more split injections, the time at which to end the last split injection being set to a time later than the predetermined time.

21: The fuel injection control method according to claim 20, wherein the fuel injected at the time near the intake stroke bottom dead center is directed to intensify a tumble flow in a cylinder.

22: The fuel injection control method according to claim 20, wherein the predetermined time is an earliest fuel injection time that causes the injected fuel to hit a top face of a piston before vaporizing.

23: The fuel injection control method according to claim 20, wherein a number of the split injections is increased as the required amount of fuel increases.

24: The fuel injection control method according to claim 20, wherein each interval between the split injections is extended as the required amount of fuel increases.

25: The fuel injection control method according to claim 20, wherein the required amount of fuel is divided into fuel amounts to be injected at the respective split injections such that the later the injection, the smaller the amount of the injected fuel will be.
